(19) United States
(12) Patent Application Publication
(10) Pub. No.: US 2026/0269916 A1
(43) Pub. Date: Sep. 10, 2026

(54) SPATIAL MULTIPLEXING ENHANCEMENTS FOR SINGLE CODEWORD TRANSMISSION WITH 6 RX CHAINS

(71) Applicant: Apple Inc., Cupertino, CA (US)

(72) Inventors: Rolando E. Bettancourt Ortega, Munich (DE); Ankit Bhamri, Bad Nauheim (DE); Dawei Zhang, Saratoga, CA (US); Konstantinos Sarrigeorgidis, Los Gatos, CA (US); Manasa Raghavan, Sunnyvale, CA (US); Qiming Li, Beijing (CN); Yang Tang, San Jose, CA (US); Yuexia Song, Beijing (CN)

(21) Appl. No.: 19/396,306

(22) Filed: Nov. 20, 2025

(30) Foreign Application Priority Data
Mar. 4, 2025 (GR) 20250100161

(51) Int. Cl. H04B 7/06; H04L 5/00; H04W 8/22

(52) U.S. Cl. CPC H04B 7/0691; H04L 5/0023; H04W 8/22

(57) ABSTRACT

The present disclosure generally relates to spatial multiplexing enhancements for single codeword transmission with five or more spatial layers. In some implementations, a user equipment (UE) is configured to determine a spatial multiplexing configuration to use for reception of at least one downlink message. The UE may determine a mapping between a single codeword and five or more spatial layers based at least on the determined spatial multiplexing configuration. The UE may receive the at least one downlink message using the determined mapping between the single codeword and the five or more spatial layers.

### CROSS-REFERENCE TO RELATED APPLICATIONS

This application claims priority to Greek Patent Application No. 20250100161, filed Mar. 4, 2025, the entirety of which is incorporated herein by reference.

### TECHNICAL FIELD

The present disclosure relates generally to wireless communication, and more specifically to a spatial multiplexing scheme for single codeword transmission with 6 receive (Rx) chains.

### BACKGROUND

Wireless communication networks provide integrated communication platforms and telecommunication services to wireless user devices. Example telecommunication services include telephony, data (e.g., voice, audio, and/or video data), messaging, and/or other services. The wireless communication networks have wireless access nodes that exchange wireless signals with the wireless user devices using one or more wireless network protocols, such as protocols described in various telecommunication standards promulgated by the European Telecommunications Standards Institute (ETSI) Third Generation Partnership Project (3GPP). The wireless communication networks facilitate mobile broadband service using technologies such as orthogonal frequency-division multiple access (OFDMA), multiple input multiple output (MIMO), advanced channel coding, massive MIMO, beamforming, and/or other features.

### SUMMARY

One aspect of the present disclosure relates to a method including: determining a spatial multiplexing configuration to use for reception of at least one downlink message; determining a mapping between a single codeword and five or more spatial layers based on the determined spatial multiplexing configuration; and receiving the at least one downlink message using the determined mapping between the single codeword and the five or more spatial layers.

In some implementations, the mapping between the single codeword and the five or more spatial layers is determined according to:

$${x}^{( 0 )} ( i ) = {d}^{( 0 )} ( 5 i )$$

$${x}^{( 1 )} ( i ) = {d}^{( 0 )} ( 5 i + 1 )$$

$${x}^{( 2 )} ( i ) = {d}^{( 0 )} ( 5 i + 2 )$$

$${x}^{( 3 )} ( i ) = {d}^{( 0 )} ( 5 i + 3 )$$

$${x}^{( 4 )} ( i ) = {d}^{( 0 )} ( 5 i + 4 ) ,$$

where x denotes a spatial layer of the five or more spatial layers, d represents the single codeword,

$$i = 0 , 1 , … , {M}_{symb}^{layer} - 1 , {M}_{symb}^{layer}$$

denotes a number of modulation symbols per spatial layer, and

$${M}_{symb}^{layer} = {M}_{symb}^{( 0 )} / 5.$$

In some implementations, determining the spatial multiplexing configuration includes selecting the spatial multiplexing configuration from a table including a set of spatial multiplexing configurations.

In some implementations, each spatial multiplexing configuration of the set of spatial multiplexing configurations is associated with a respective number of spatial layers and a respective number of codewords.

In some implementations, the determined spatial multiplexing configuration indicates the mapping between the single codeword and the five or more spatial layers.

In some implementations, the method further includes determining an antenna port configuration to use for downlink reception based on the determined spatial multiplexing configuration.

In some implementations, determining the antenna port configuration includes selecting the antenna port configuration from a table including a set of entries, where each entry of the set of entries corresponds to a distinct antenna port configuration.

In some implementations, determining the antenna port configuration includes receiving downlink control information (DCI) that indicates the antenna port configuration.

In some implementations, determining the mapping between the single codeword and the five or more spatial layers includes determining the mapping between the single codeword and six spatial layers based on the determined spatial multiplexing configuration.

In some implementations, the method further includes transmitting user equipment (UE) capability information that indicates whether five-layer single-codeword reception or five-layer two-codeword reception is supported by a UE.

In some implementations, the spatial multiplexing configuration is determined according to the UE capability information.

In some implementations, receiving the at least one downlink message includes receiving the at least one downlink message using five or more receive (Rx) chains in accordance with the determined spatial multiplexing configuration.

Another aspect of the present disclosure relates to an apparatus including: one or more processors; and memory storing instructions that, when executed by the one or more processors, cause the apparatus to perform any of the foregoing operations.

Another aspect of the present disclosure relates to a UE configured to perform any of the foregoing operations.

Another aspect of the present disclosure relates to a method including: determining a spatial multiplexing configuration to use for transmission of at least one downlink message; determining a mapping between a single codeword and five or more spatial layers based on the determined spatial multiplexing configuration; and transmitting the at least one downlink message using the determined mapping between the single codeword and the five or more spatial layers.

In some implementations, the mapping between the single codeword and the five or more spatial layers is determined according to:

$${x}^{( 0 )} ( i ) = {d}^{( 0 )} ( 5 i )$$

$${x}^{( 1 )} ( i ) = {d}^{( 0 )} ( 5 i + 1 )$$

$${x}^{( 2 )} ( i ) = {d}^{( 0 )} ( 5 i + 2 )$$

$${x}^{( 3 )} ( i ) = {d}^{( 0 )} ( 5 i + 3 )$$

$${x}^{( 4 )} ( i ) = {d}^{( 0 )} ( 5 i + 4 ) ,$$

where x denotes a spatial layer of the five or more spatial layers, d represents the single codeword,

$$i = 0 , 1 , … , {M}_{symb}^{layer} - 1 , {M}_{symb}^{layer}$$

denotes a number of modulation symbols per spatial layer, and

$${M}_{symb}^{layer} = {M}_{symb}^{( 0 )} / 5.$$

In some implementations, determining the spatial multiplexing configuration includes selecting the spatial multiplexing configuration from a table including a set of spatial multiplexing configurations.

In some implementations, each spatial multiplexing configuration of the set of spatial multiplexing configurations is associated with a respective number of spatial layers and a respective number of codewords.

Another aspect of the present disclosure relates to an apparatus including: one or more processors; and memory storing instructions that, when executed by the one or more processors, cause the apparatus to perform any of the foregoing operations.

Another aspect of the present disclosure relates to a base station configured to perform any of the foregoing operations.

The details of one or more embodiments of the present disclosure are set forth in the accompanying drawings and the description below. Other features, objects, and advantages will be apparent from the description and drawings, and from the claims.

### BRIEF DESCRIPTION OF THE FIGURES

FIG. 1 illustrates an example wireless network, according to some implementations.

FIG. 2 illustrates an example signaling diagram, according to some implementations.

FIG. 3 illustrates a flowchart of an example method for single codeword reception with 6 receive (Rx) chains, according to some implementations.

FIG. 4 illustrates a flowchart of an example method for single-codeword transmission with 6 spatial layers, according to some implementations.

FIG. 5 illustrates an example UE, according to some implementations.

FIG. 6 illustrates an example access node, according to some implementations.

### DETAILED DESCRIPTION

A user equipment (UE) may have up to 6 receive (Rx) chains that can be used for multiple-input multiple-output (MIMO) communications. An Rx chain typically includes a combination of hardware and signal processing components (e.g., amplifiers, filters, converters) that process signals received by a radio frequency (RF) front-end module of the UE. MIMO is a type of wireless communication that leverages spatial multiplexing, beamforming, and diversity gain to improve system throughput and transmission reliability. UEs that support MIMO can use multiple Rx chains to concurrently process different signals. Some wireless networks support different MIMO communication schemes. Each MIMO scheme has a number of spatial layers (also referred to as Rank) and a number of codewords. Using more than one codeword for MIMO operations can increase the baseband complexity of the UE, which may be undesirable in some cases.

In accordance with aspects of the present disclosure, a UE can support up to 6 MIMO layers (e.g., Rank 6) with a single codeword, which can provide greater throughput/reliability for devices with lower-complexity receivers. For example, a UE may be configured with a first table that includes various codeword-to-layer mapping entries. The UE may determine to use a single codeword and five or more MIMO layers (e.g., Rank 5 and above) for downlink reception. The UE may determine a mapping between the 5 or more MIMO layers and the single codeword based on the first table. In some implementations, the UE may be configured with a second table that includes various antenna port configurations. The UE may receive downlink control information (DCI) that indicates a particular entry of the second table. The UE may determine which antenna port configuration to use for downlink reception based on the entry of the second table indicated by the DCI.

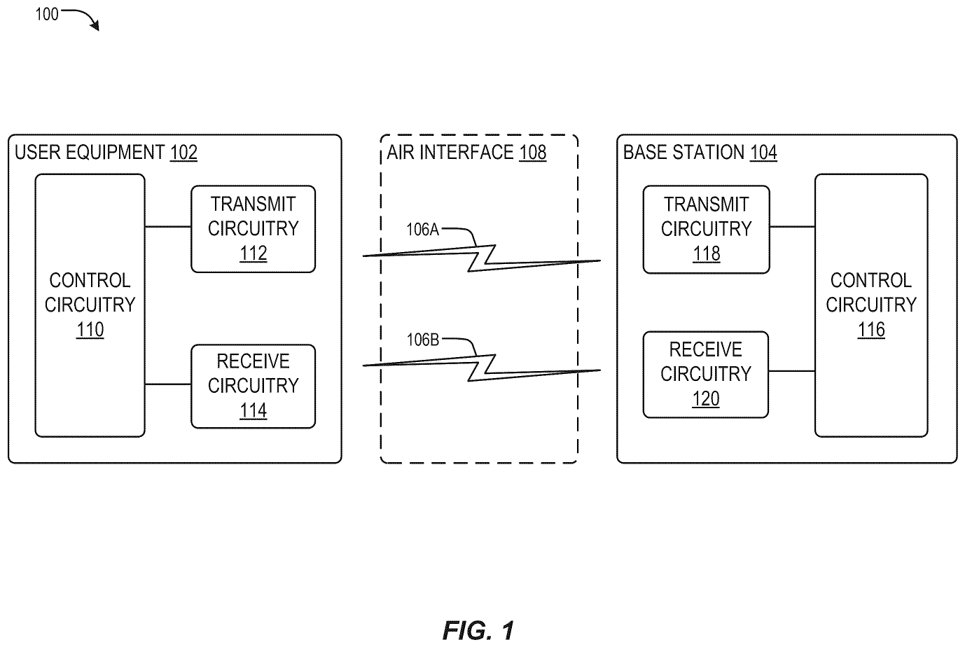

FIG. 1 illustrates an example wireless network 100, according to some implementations.

The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104.

In some implementations, the wireless network 100 is a Standalone (SA) network, e.g., that incorporates Fifth Generation (5G) New Radio (NR). In some other implementations, the wireless network 100 is a Non-Standalone (NSA) network that incorporates Long Term Evolution (LTE) and 5G NR. In these implementations, the wireless network 100 may be a E-UTRA (Evolved Universal Terrestrial Radio Access)-NR Dual Connectivity (EN-DC) network, or an NR-EUTRA Dual Connectivity (NE-DC) network. Furthermore, wireless networks implementing one or more other types of communication standards are possible, including future 3GPP systems (e.g., Sixth Generation (6G)), Institute of Electrical and Electronics Engineers (IEEE) 802.11 technology, or the like. While aspects may be described herein using terminology commonly associated with 5G NR, aspects of the present disclosure can be applied to other systems, such as systems subsequent to 5G (e.g., 6G).

In the wireless network 100, the UE 102 and any other UE in the system may be, for example, any of a laptop computer, smartphone, tablet computer, machine-type device (such as smart meters or specialized devices for healthcare), intelligent transportation system, or any other wireless device. In network 100, the base station 104 provides the UE 102 network connectivity to a broader network (not shown). This UE 102 connectivity is provided via the air interface 108 in a base station service area provided by the base station 104. In some implementations, such a broader network may be a wide area network operated by a cellular network provider, or may be the Internet. Each base station service area associated with the base station 104 is supported by one or more antennas integrated with the base station 104. The service areas can be divided into a number of sectors associated with one or more particular antennas. Such sectors may be physically associated with one or more fixed antennas or may be assigned to a physical area with one or more tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may include application-specific circuitry, baseband circuitry, or any of various combinations thereof. The transmit circuitry 112 and receive circuitry 114 may be adapted to transmit and receive data, respectively, and may include radio frequency (RF) circuitry and/or front-end module (FEM) circuitry.

In various implementations, aspects of the transmit circuitry 112, receive circuitry 114, and/or control circuitry 110 may be integrated in various ways to implement the operations described herein. The control circuitry 110 may be adapted or configured to perform various operations, such as those described elsewhere in this disclosure related to a UE. For example, the control circuitry 110 can determine a mapping between a single codeword and five or more spatial layers based on a spatial multiplexing configuration.

The transmit circuitry 112 can perform various operations described herein. For example, the transmit circuitry 112 can transmit capability information that indicates whether the UE 102 supports single codeword reception with 5 or more spatial layers (e.g., whether single codeword is supported for only 5 layers, 5 or 6 layers, more than 6 layers). Additionally, the transmit circuitry 112 may transmit using multiplexed uplink physical channels. The uplink physical channels may be multiplexed, e.g., according to time division multiplexing (TDM) or frequency division multiplexing (FDM), and in some implementations, along with carrier aggregation (CA). The transmit circuitry 112 may be configured to receive block data from the control circuitry 110 for transmission on the air interface 108.

The receive circuitry 114 can perform various operations described herein. For instance, the receive circuitry 114 can receive at least one downlink message using the determined mapping between the single codeword and the five or more spatial layers. Additionally, the receive circuitry 114 may receive multiplexed downlink physical channels from the air interface 108 and relay the physical channels to the control circuitry 110. The downlink physical channels may be multiplexed, e.g., according to TDM or FDM, e.g., along with CA. The transmit circuitry 112 and the receive circuitry 114 may transmit and receive, respectively, both control data and content data (e.g., messages, images, video, etc.) structured within data blocks that are carried by the physical channels.

FIG. 1 also illustrates the base station 104. In some implementations, the base station 104 may be a 5G radio access network (RAN), a next generation RAN, a E-UTRAN, a non-terrestrial cell, or a legacy RAN, such as a UTRAN. As used herein, the term “5G RAN” or the like may refer to the base station 104 that operates in an NR wireless network 100, and the term “E-UTRAN” or the like may refer to a base station 104 that operates in an LTE wireless network 100.

The UE 102 utilizes connections (or channels) 106A, 106B, each of which includes a physical communications interface or layer.

The base station 104 circuitry may include control circuitry 116 coupled (directly or indirectly) with transmit circuitry 118 and/or receive circuitry 120. The transmit circuitry 118 and receive circuitry 120 may each be coupled (directly or indirectly) with one or more antennas that may be used to enable communications via the air interface 108. The transmit circuitry 118 and receive circuitry 120 may be adapted to transmit and receive data, respectively, addressed to any UE connected to the base station 104. The receive circuitry 120 may receive uplink physical channels from one or more UEs, including the UE 102.

In FIG. 1, the one or more channels 106A, 106B are illustrated as an air interface to enable communicative coupling, and can be consistent with cellular communications protocols, such as an LTE protocol, Advanced LTE (LTE-A) protocol, LTE-based access to unlicensed spectrum (LTE-U), NR protocol, NR-based access to unlicensed spectrum (NR-U) protocol, and/or any other communications protocol(s). In some implementations, the UE 102 may directly exchange communication data via a ProSe interface. The ProSe interface may alternatively be referred to as a sidelink (SL) interface and may include one or more logical channels, including but not limited to a Physical Sidelink Control Channel (PSCCH), a Physical Sidelink Discovery Channel (PSDCH), and a Physical Sidelink Broadcast Channel (PSBCH).

The spatial multiplexing enhancements described herein relate to 6 Rx chain, Rank 5 transmission with a single codeword for handheld UEs (such as the UE 102 of FIG. 1). As described herein, some fixed wireless access (FWA) devices and handheld UEs can support a higher number of Rx chains. RF enhancements for NR frequency range 1 (FR1)/frequency range 2 (FR2) and EN-DC in 3GPP Release 19 cover high-power UEs for CA in terrestrial networks, power boosting and/or maximum power reduction (MPR), and 6 Rx chains for handheld and FWA UEs. 6 Rx chains can be enabled for higher frequency bands (e.g., >2.5 GHz), targeting handheld UE support for NR FR1 single carrier scenarios. These enhancements can be used in various frequency bands, including (but not limited to) n41, n77/n78, n79, and n104. Using 6 Rx chains would allow handheld UEs to support at least 4 MIMO layers, up to 6 MIMO layers in some cases.

Increasing the number of Rx chains to 6 for larger form-factor UEs can improve downlink coverage, but having more antennas in a smaller area can affect MIMO performance. Attaining full rank typically requires strong antenna isolation and low correlation, which may be difficult to maintain. Rank 6 can yield performance gains at moderate UE signal to noise ratio (SNR) levels, but may increase the baseband complexity of two-codeword reception at the UE. UE reception conditions typically include an SNR below 40 dB (SNR<<40 dB), a transmit (Tx) error vector magnitude (EVM) value of at least 1-2%, and a non-ideal Rx antenna correlation. Compared to Rank 4, Rank 5 can provide reasonable performance gains. For Rank 6, performance gains often come at higher SNR values. Rank 5 can be a more suitable option for receivers with lower complexity or reduced capabilities.

Channel estimation, demodulation reference signal (DMRS)-based interference estimation, MIMO detection, and channel decoding can increase the baseband complexity of a UE. Using 6 MIMO layers can lead to increased baseband complexity and power consumption (relative to 4 MIMO layers). Support for 6 MIMO layers may be optional. For 6-layer support, a Tx EVM of 1% or 3% may be assumed for all modulation orders. A Tx EVM of 6% may be considered for 64-bit quadrature amplitude modulation (QAM) and a Tx EVM of 3% may be considered for 256-bit QAM.

It may be desirable to limit the complexity of higher rank transmissions for typical reception conditions. 3GPP currently mandates two-codeword transmission for Rank 5 and above.

There is an increase in complexity between single-codeword and two-codeword transmission and signaling. The performance gains from Rank 4 to Rank 5 may be comparatively less than the performance gains from Rank 4 to Rank 8. Increasing support of single-codeword transmission up to Rank 5 (possibly Rank 6) can help reduce UE implementation complexity in several ways.

Changes may be needed to support single-codeword transmission in Rank 5. The number of layers and the number of codewords has a 1:1 correspondence in the 3GPP specification. Currently, single-codeword transmission is only supported for Rank 4 and below. Two-codeword transmission is supported for Rank 5 to Rank 8. In accordance with aspects of the present disclosure, the mapping between spatial layers and codewords may be expanded to support Rank 5 single-codeword transmission. The DCI antenna port indication field (defined in 3GPP TS 38.212) may be amended to support Rank 5 single-codeword transmission. The techniques described herein may reduce the overhead of hybrid automatic repeat request (HARQ) acknowledgement (ACK) and channel state information (CSI) feedback for two-codeword transmission, as the UE 102 can fall back to one-codeword transmission.

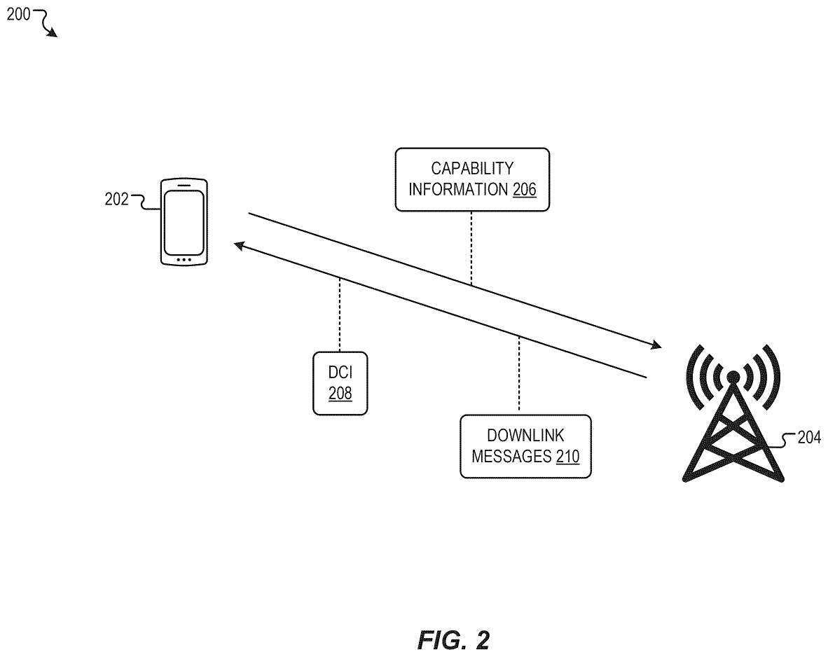

FIG. 2 illustrates an example signaling diagram 200, according to some implementations.

The example signaling diagram 200 of FIG. 2 may implement one or more aspects of the wireless network 100. For example, the signaling diagram 200 includes a UE 202, which may be an example of the UE 102 shown and described with reference to FIG. 1. The signaling diagram 200 also includes a base station 204, which may be an example of the base station 104 shown and described with reference to FIG. 1.

As described herein, the present disclosure generally relates to enabling 6 MIMO layers with a single codeword, which can provide greater throughput/reliability for devices with lower-complexity receivers. In the example signaling diagram 200, the UE 202 may be configured with a first table (similar to Table 7.3.1.3-1 of 3GPP TS 38.211) that includes various codeword-to-layer mapping entries. The UE 202 may determine to use 5 or more MIMO layers and a single codeword for reception of downlink messages 210. The base station 204 may transmit DCI 208 that indicates an entry of the first table. The UE 202 may determine a mapping between the 5 MIMO layers and the single codeword based on the entry indicated by the DCI 208. In some implementations, the UE 202 is configured with a second table (similar to Table 7.3.1.2.2-2 or 7.3.1.2.2-3 of 3GPP TS 38.212) that includes various antenna port configurations. The UE 202 may determine which antenna port configuration to use for reception of the downlink messages 210 based on the second table, the DCI 208, and the number of codewords enabled.

To support 6 MIMO layers with a single codeword, a mapping between 5 spatial layers and 1 codeword may be added to Table 7.3.1.3-1 of 3GPP TS 38.211 (as shown below). Alternatively, a new table may be specified in 3GPP TS 38.211. This table may have an entry with a codeword-to-layer mapping for 5 layers and 1 codeword.

TABLE 7.3.1.3-1
Codeword-to-layer mapping for spatial multiplexing

| | | Codeword-to-layer mapping |
|---|---|---|
| Number of layers | Number of codewords | $i = 0 , 1 , … , {M}_{symb}^{layer} - 1$ |
| 1 | 1 | $\begin{matrix}{x}^{( 0 )} ( i ) = {d}^{( 0 )} ( i ) & {M}_{symb}^{layer}\end{matrix} = {M}_{symb}^{( 0 )}$ |
| 2 | 1 | $\begin{matrix}\begin{matrix}{x}^{( 0 )} ( i ) = {d}^{( 0 )} ( 2 i ) \\ {x}^{( 1 )} ( i ) = {d}^{( 0 )} ( 2 i + 1 )\end{matrix} & {M}_{symb}^{layer} =\end{matrix} {M}_{symb}^{( 0 )} / 2$ |
| 3 | 1 | $\begin{matrix}\begin{matrix}{x}^{( 0 )} ( i ) = {d}^{( 0 )} ( 3 i ) \\ {x}^{( 1 )} ( i ) = {d}^{( 0 )} ( 3 i + 1 ) \\ {x}^{( 2 )} ( i ) = {d}^{( 0 )} ( 3 i + 2 )\end{matrix} & {M}_{symb}^{layer} =\end{matrix} {M}_{symb}^{( 0 )} / 3$ |
| 4 | 1 | $\begin{matrix}\begin{matrix}{x}^{( 0 )} ( i ) = {d}^{( 0 )} ( 4 i ) \\ {x}^{( 1 )} ( i ) = {d}^{( 0 )} ( 4 i + 1 ) \\ {x}^{( 2 )} ( i ) = {d}^{( 0 )} ( 4 i + 2 ) \\ {x}^{( 3 )} ( i ) = {d}^{( 0 )} ( 4 i + 3 )\end{matrix} & {M}_{symb}^{layer}\end{matrix} = {M}_{symb}^{( 0 )} / 4$ |
| 5 | 1 | $\begin{matrix}\begin{matrix}{x}^{( 0 )} ( i ) = {d}^{( 0 )} ( 5 i ) \\ {x}^{( 1 )} ( i ) = {d}^{( 0 )} ( 5 i + 1 ) \\ {x}^{( 2 )} ( i ) = {d}^{( 0 )} ( 5 i + 2 ) \\ {x}^{( 3 )} ( i ) = {d}^{( 0 )} ( 5 i + 3 ) \\ {x}^{( 4 )} ( i ) = {d}^{( 0 )} ( 5 i + 4 )\end{matrix} & {M}_{symb}^{layer} =\end{matrix} {M}_{symb}^{( 0 )} / 5$ |
| 5 | 2 | $\begin{matrix}\begin{matrix}{x}^{( 0 )} ( i ) = {d}^{( 0 )} ( 2 i ) \\ {x}^{( 1 )} ( i ) = {d}^{( 0 )} ( 2 i + 1 ) \\ {x}^{( 2 )} ( i ) = {d}^{( 1 )} ( 3 i ) \\ {x}^{( 3 )} ( i ) = {d}^{( 1 )} ( 3 i + 1 ) \\ {x}^{( 4 )} ( i ) = {d}^{( 1 )} ( 3 i + 2 )\end{matrix} & {M}_{symb}^{layer}\end{matrix} = {M}_{symb}^{( 0 )} / 2 = {M}_{symb}^{( 1 )} / 3$ |
| 6 | 2 | $\begin{matrix}{x}^{( 0 )} ( i ) = {d}^{( 0 )} ( 3 i ) \\ {x}^{( 1 )} ( i ) = {d}^{( 0 )} ( 3 i + 1 ) \\ {x}^{( 2 )} ( i ) = {d}^{( 0 )} ( 3 i + 2 ) \\ {x}^{( 3 )} ( i ) = {d}^{( 1 )} ( 3 i ) \\ {x}^{( 4 )} ( i ) = {d}^{( 1 )} ( 3 i + 1 ) \\ {x}^{( 5 )} ( i ) = {d}^{( 1 )} ( 3 i + 2 )\end{matrix} \qquad {M}_{symb}^{layer} = {M}_{symb}^{( 0 )} / 3 = {M}_{symb}^{( 1 )} / 3$ |
| 7 | 2 | $\begin{matrix}\begin{matrix}{x}^{( 0 )} ( i ) = {d}^{( 0 )} ( 3 i ) \\ {x}^{( 1 )} ( i ) = {d}^{( 0 )} ( 3 i + 1 ) \\ {x}^{( 2 )} ( i ) = {d}^{( 0 )} ( 3 i + 2 ) \\ {x}^{( 3 )} ( i ) = {d}^{( 1 )} ( 4 i ) \\ {x}^{( 4 )} ( i ) = {d}^{( 1 )} ( 4 i + 1 ) \\ {x}^{( 5 )} ( i ) = {d}^{( 1 )} ( 4 i + 2 ) \\ {x}^{( 6 )} ( i ) = {d}^{( 1 )} ( 4 i + 3 )\end{matrix} & {M}_{symb}^{layer} =\end{matrix} {M}_{symb}^{( 0 )} / 3 = {M}_{symb}^{( 1 )} / 4$ |
| 8 | 2 | $\begin{matrix}\begin{matrix}{x}^{( 0 )} ( i ) = {d}^{( 0 )} ( 4 i ) \\ {x}^{( 1 )} ( i ) = {d}^{( 0 )} ( 4 i + 1 ) \\ {x}^{( 2 )} ( i ) = {d}^{( 0 )} ( 4 i + 2 ) \\ {x}^{( 3 )} ( i ) = {d}^{( 0 )} ( 4 i + 3 ) \\ {x}^{( 4 )} ( i ) = {d}^{( 1 )} ( 4 i ) \\ {x}^{( 5 )} ( i ) = {d}^{( 1 )} ( 4 i + 1 ) \\ {x}^{( 6 )} ( i ) = {d}^{( 1 )} ( 4 i + 2 ) \\ {x}^{( 7 )} ( i ) = {d}^{( 1 )} ( 4 i + 3 )\end{matrix} & {M}_{symb}^{layer} =\end{matrix} {M}_{symb}^{( 0 )} / 4 = {M}_{symb}^{( 1 )} / 4$ |

Tables 7.3.1.2.2-2 and 7.3.1.2.2-3 of 3GPP TS 38.211 specify different antenna port configurations for single-codeword transmission and two-codeword transmission. These tables may be updated to support single-codeword transmission for Rank 5 and above. For example, at least one new entry may be added to Table 7.3.1.2.2-2 and/or 7.3.1.2.2-3. This new entry may specify which antenna port configuration to use for single-codeword transmission with 5 or more MIMO layers.

TABLE 7.3.1.2.2-2
Antenna port(s) (1000 + DMRS port), dmrs-Type = 1,
dmrs-TypeEnh is not configured, maxLength = 2

| One Codeword: | | | | Two Codewords: | | | |
|---|---|---|---|---|---|---|---|
| Codeword 0 enabled, | | | | Codeword 0 enabled, | | | |
| Codeword 1 disabled | | | | Codeword 1 enabled | | | |
| | Number of | | | | Number of | | |
| | DMRS CDM | | Number of | | DMRS CDM | | Number of |
| | group(s) | DMRS | front-load | | group(s) | DMRS | front-load |
| Value | without data | port(s) | symbols | Value | without data | port(s) | symbols |
| 0 | 1 | 0 | 1 | 0 | 2 | 0-4 | 2 |
| 1 | 1 | 1 | 1 | 1 | 2 | 0, 1, 2, 3, 4, 6 | 2 |
| 2 | 1 | 0, 1 | 1 | 2 | 2 | 0, 1, 2, 3, 4, 5, 6 | 2 |
| 3 | 2 | 0 | 1 | 3 | 2 | 0, 1, 2, 3, 4, 5, 6, 7 | 2 |
| 4 | 2 | 1 | 1 | 4-31 | reserved | reserved | reserved |
| 5 | 2 | 2 | 1 | | | | |
| 6 | 2 | 3 | 1 | | | | |
| 7 | 2 | 0, 1 | 1 | | | | |
| 8 | 2 | 2, 3 | 1 | | | | |
| 9 | 2 | 0-2 | 1 | | | | |
| 10 | 2 | 0-3 | 1 | | | | |
| 11 | 2 | 0, 2 | 1 | | | | |
| 12 | 2 | 0 | 2 | | | | |
| 13 | 2 | 1 | 2 | | | | |
| 14 | 2 | 2 | 2 | | | | |
| 15 | 2 | 3 | 2 | | | | |
| 16 | 2 | 4 | 2 | | | | |
| 17 | 2 | 5 | 2 | | | | |
| 18 | 2 | 6 | 2 | | | | |
| 19 | 2 | 7 | 2 | | | | |
| 20 | 2 | 0, 1 | 2 | | | | |
| 21 | 2 | 2, 3 | 2 | | | | |
| 22 | 2 | 4, 5 | 2 | | | | |
| 23 | 2 | 6, 7 | 2 | | | | |
| 24 | 2 | 0, 4 | 2 | | | | |
| 25 | 2 | 2, 6 | 2 | | | | |
| 26 | 2 | 0, 1, 4 | 2 | | | | |
| 27 | 2 | 2, 3, 6 | 2 | | | | |
| 28 | 2 | 0, 1, 4, 5 | 2 | | | | |
| 29 | 2 | 2, 3, 6, 7 | 2 | | | | |
| 30 | 2 | 0, 2, 4, 6 | 2 | | | | |
| 31 | Reserved | Reserved | Reserved | | | | |

Table 7.3.1.2.2-3: Antenna port(s) (1000+DMRS port), dmrs-Type=2, dmrs-TypeEnh is not configured, maxLength=1

TABLE 7.3.1.2.2-3
Antenna ports(s) (1000 + DMRS port), dmrs-Type = 2,
dmrs-TypeEnh is not configured, maxLength = 1

| One codeword: | | | Two codewords: | | |
|---|---|---|---|---|---|
| Codeword 0 enabled, | | | Codeword 0 enabled, | | |
| Codeword 1 disable | | | Codeword 1 enabled | | |
| | Number of | | | Number of | |
| | DMRS CDM | | | DMRS CDM | |
| | group(s) | DMRS | | group(s) | DMRS |
| Value | without data | port(s) | Value | without data | port(s) |
| 0 | 1 | 0 | 0 | 3 | 0-4 |
| 1 | 1 | 1 | 1 | 3 | 0-5 |
| 2 | 1 | 0, 1 | 2-31 | reserved | reserved |
| 3 | 2 | 0 | | | |
| 4 | 2 | 1 | | | |
| 5 | 2 | 2 | | | |
| 6 | 2 | 3 | | | |
| 7 | 2 | 0, 1 | | | |
| 8 | 2 | 2, 3 | | | |
| 9 | 2 | 0-2 | | | |
| 10 | 2 | 0-3 | | | |
| 11 | 3 | 0 | | | |
| 12 | 3 | 1 | | | |
| 13 | 3 | 2 | | | |
| 14 | 3 | 3 | | | |
| 15 | 3 | 4 | | | |
| 16 | 3 | 5 | | | |
| 17 | 3 | 0, 1 | | | |
| 18 | 3 | 2, 3 | | | |
| 19 | 3 | 4, 5 | | | |
| 20 | 3 | 0-2 | | | |
| 21 | 3 | 3-5 | | | |
| 22 | 3 | 0-3 | | | |
| 23 | 2 | 0, 2 | | | |
| 24-31 | Reserved | Reserved | | | |

In some implementations, the UE 202 transmits capability information 206 to the base station 204. The capability information 206 may indicate a capability of the UE 202 to support Rank 4 and above with 1 codeword, allowing the UE 202 to process additional MIMO layers without the added complexity of supporting 2 codewords. In some implementations, the capability information 206 (also referred to as UE capability signaling) indicates whether the UE 202 supports per-codeword HARQ-ACK and channel quality indicator (CQI) reporting. This UE capability signaling can help the network (e.g., the base station 204) with scheduling operations.

The capability information 206 may also indicate a capability of the UE 202 to support Rank 4 and above with 2 codewords. The UE 202 can revert to legacy behavior when more than 4 MIMO layers are supported. The UE 202 may employ per-codeword interference cancellation (IC) techniques to cancel inter-stream interference and attain better performance than with a single codeword. With 2 codewords, the network (e.g., the base station 204) has greater flexibility when scheduling communications with the UE 202 because a different modulation and coding scheme (MCS) can be used for each codeword. However, the processing complexity of the UE 202 may increase with 2 codeword processing.

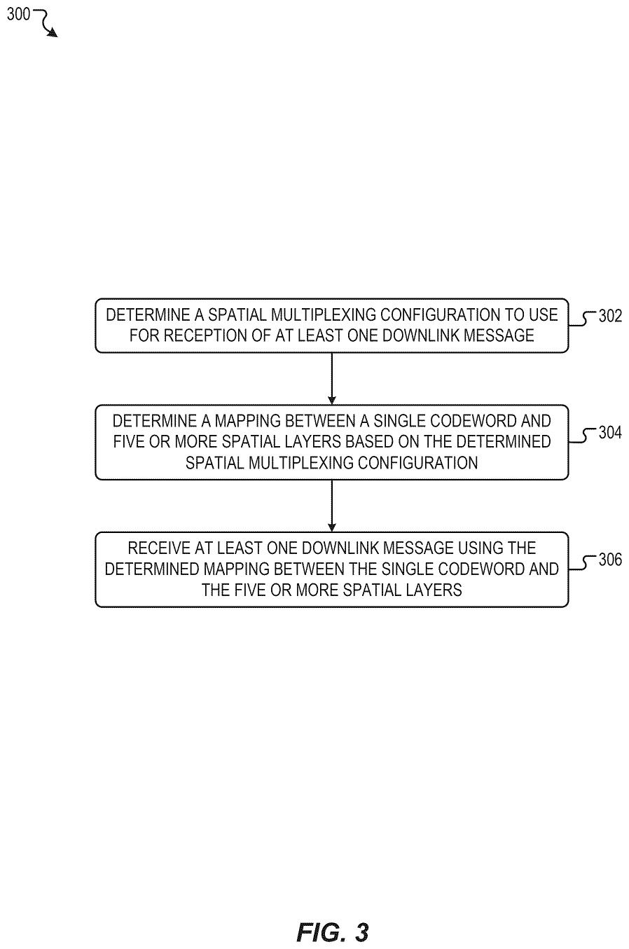

FIG. 3 illustrates a flowchart of an example method 300 for single codeword reception with 6 Rx chains, according to some implementations. For clarity of presentation, the method 300 is generally described in the context of the preceding figures. For example, some operations of the method 300 can be performed by a UE (such as the UE 102 of FIG. 1), or by any suitable system, environment, hardware, software, or combination thereof. In some implementations, operations of the method 300 occur in parallel, in combination, in loops, or in any order. The example method 300 shown in FIG. 3 can be modified or reconfigured to include additional, fewer, or different steps (not shown in FIG. 3).

At 302, the UE determines a spatial multiplexing configuration to use for reception of at least one downlink message. For example, the UE may select a spatial multiplexing configuration from Table 7.3.1.3-1 of 3GPP TS 38.211 (shown above).

At 304, the UE determines a mapping between a single codeword and five or more spatial layers (e.g., MIMO layers) based on the determined spatial multiplexing configuration.

At 306, the UE receives the at least one downlink message using the determined mapping between the single codeword and the five or more spatial layers.

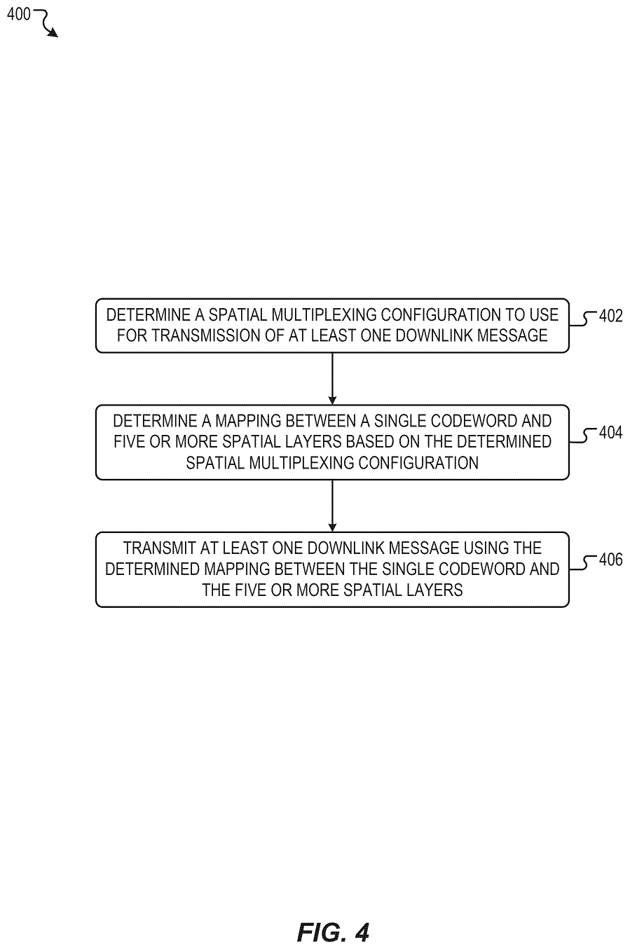

FIG. 4 illustrates a flowchart of an example method 400 for single codeword transmission with 6 spatial layers, according to some implementations. For clarity of presentation, the method 400 is generally described in the context of the preceding figures. For example, some operations of the method 400 can be performed by an access node (such as the base station 104 of FIG. 1), or by any suitable system, environment, hardware, software, or combination thereof. In some implementations, operations of the method 400 occur in parallel, in combination, in loops, or in any order. The example method 400 shown in FIG. 4 can be modified or reconfigured to include additional, fewer, or different steps (not shown in FIG. 4).

At 402, the access node determines a spatial multiplexing configuration to use for transmission of at least one downlink message. For example, the access node may select a spatial multiplexing configuration from Table 7.3.1.3-1 of 3GPP TS 38.211 (shown above).

At 404, the access node determines a mapping between a single codeword and five or more spatial layers (e.g., MIMO layers) based on the determined spatial multiplexing configuration.

At 406, the access node transmits the at least one downlink message using the determined mapping between the single codeword and the five or more spatial layers.

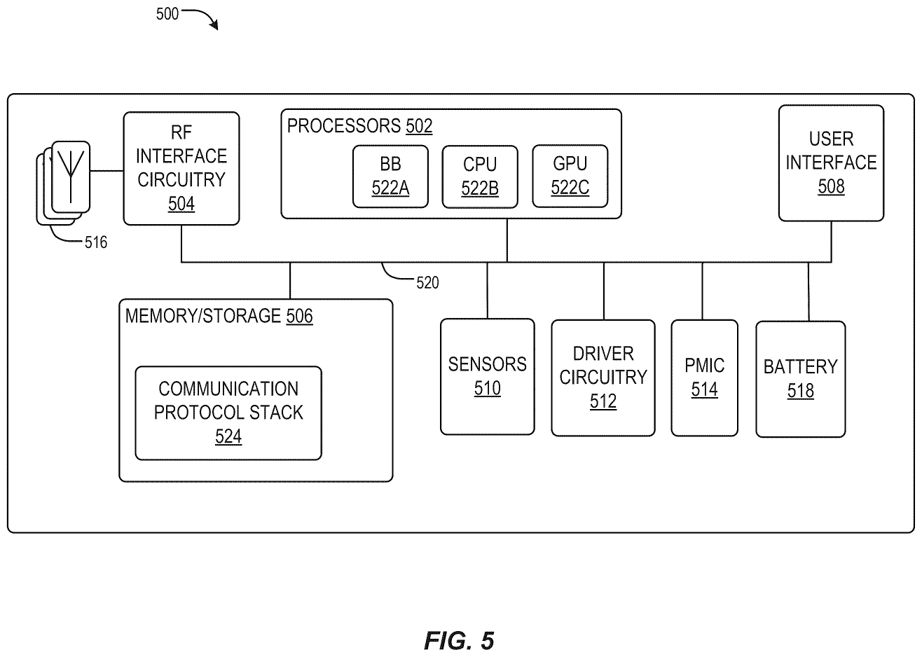

FIG. 5 illustrates an example UE 500, according to some implementations. The UE 500 may be similar to and substantially interchangeable with UE 102 of FIG. 1. The UE 500 may be any mobile or non-mobile computing device, such as, for example, a mobile phone, computer, tablet, industrial wireless sensors, video device (e.g., cameras, video cameras), wearable devices (e.g., a smart watch), relaxed-IoT devices, etc.

The UE 500 may include any/all of processor 502, RF interface circuitry 504, memory/storage 506, user interface 508, sensors 510, driver circuitry 512, power management integrated circuit (PMIC) 514, one or more antenna(s) 516, and battery 518. The components of the UE 500 may be implemented as integrated circuits (ICs), portions thereof, discrete electronic devices, or other modules, logic, hardware, software, firmware, or a combination thereof. The block diagram of FIG. 5 is intended to show a high-level view of some of the components of the UE 500. However, some of the components shown may be omitted, additional components may be present, and a different arrangement of the components shown may occur in other implementations.

The components of the UE 500 may be coupled with various other components over one or more interconnects 520, which may represent any type of interface, input/output, bus (local, system, or expansion), transmission line, trace, optical connection, etc., that allows various circuit components (on common or different chips or chipsets) to interact with one another.

The processor 502 may include one or more processors. For example, the processor 502 may include processor circuitry such as, for example, baseband processor circuitry (BB) 522A, central processor unit circuitry (CPU) 522B, and graphics processor unit circuitry (GPU) 522C.

The processor 502 may include any type of circuitry or processor circuitry that executes or otherwise operates computer-executable instructions, such as program code, software modules, or functional processes from memory/storage 506 to cause the UE 500 to perform operations as described herein.

In some implementations, the baseband processor circuitry 522A may access a communication protocol stack 524 in the memory/storage 506 to communicate over a 3GPP compatible network. In general, the baseband processor circuitry 522A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 504. The baseband processor circuitry 522A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 506 may include one or more non-transitory, computer-readable media that includes instructions (for example, communication protocol stack 524) that may be executed by the processor 502 to cause the UE 500 to perform various operations described herein.

The memory/storage 506 include any type of volatile or non-volatile memory that may be distributed throughout the UE 500. In some implementations, some of the memory/storage 506 may be located on the processor 502 itself (for example, L1 and L2 cache), while other memory/storage 506 is external to the processor 502 but accessible thereto via a memory interface.

The memory/storage 506 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 504 may include transceiver circuitry and radio frequency front module (RFEM) that allows the UE 500 to communicate with other devices over a radio access network. The RF interface circuitry 504 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna(s) 516 and proceed to filter and amplify (with a low-noise amplifier) the signal. The signal may be provided to a receiver of the transceiver that downconverts the RF signal into a baseband signal that is provided to the baseband processor.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna(s) 516. In various implementations, the RF interface circuitry 504 may be configured to transmit/receive signals in a manner compatible with NR access technologies.

The antenna(s) 516 may include one or more antenna elements to convert electrical signals into radio waves to travel through the air and to convert received radio waves over the air into electrical signals. In some implementations, the antenna elements may be arranged into one or more antenna panels. The antenna(s) 516 may have antenna panels that are omnidirectional, directional, or a combination thereof, to enable beamforming and multiple input, multiple output communications. The antenna(s) 516 may include any/all of microstrip antennas, printed antennas fabricated on the surface of one or more printed circuit boards, patch antennas, phased array antennas, etc. The antenna(s) 516 may have one or more panels designed for one or more specific frequency bands, such as bands in FR1 or FR2.

The user interface 508 includes various input/output (I/O) devices designed to enable user interaction with the UE 500. The user interface 508 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 500.

The sensors 510 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 512 may include software and hardware elements that operate to control particular devices that are embedded in the UE 500, attached to the UE 500, or otherwise communicatively coupled with the UE 500. The driver circuitry 512 may include individual drivers allowing other components to interact with or control various input/output (I/O) devices that may be present within, or connected to, the UE 500. For example, driver circuitry 512 may include a display driver to control and allow access to a display device, a touchscreen driver to control and allow access to a touchscreen interface, sensor drivers to obtain sensor readings of sensors 510 and control and allow access to sensors 510, drivers to obtain actuator positions of electro-mechanic components or control and allow access to the electro-mechanic components, a camera driver to control and allow access to an embedded image capture device, audio drivers to control and allow access to one or more audio devices.

The PMIC 514 may manage power provided to various components of the UE 500. In particular, with respect to the processor 502, the PMIC 514 may control power-source selection, voltage scaling, battery charging, or DC-to-DC conversion.

In some implementations, the PMIC 514 may control, or otherwise be part of, various power saving mechanisms of the UE 500. A battery 518 may power the UE 500, although in some examples the UE 500 may be mounted deployed in a fixed location and may have a power supply coupled to an electrical grid. The battery 518 may be a lithium ion battery, a metal-air battery, such as a zinc-air battery, an aluminum-air battery, a lithium-air battery, and the like. In some implementations, such as in vehicle-based applications, the battery 518 may be a typical lead-acid automotive battery.

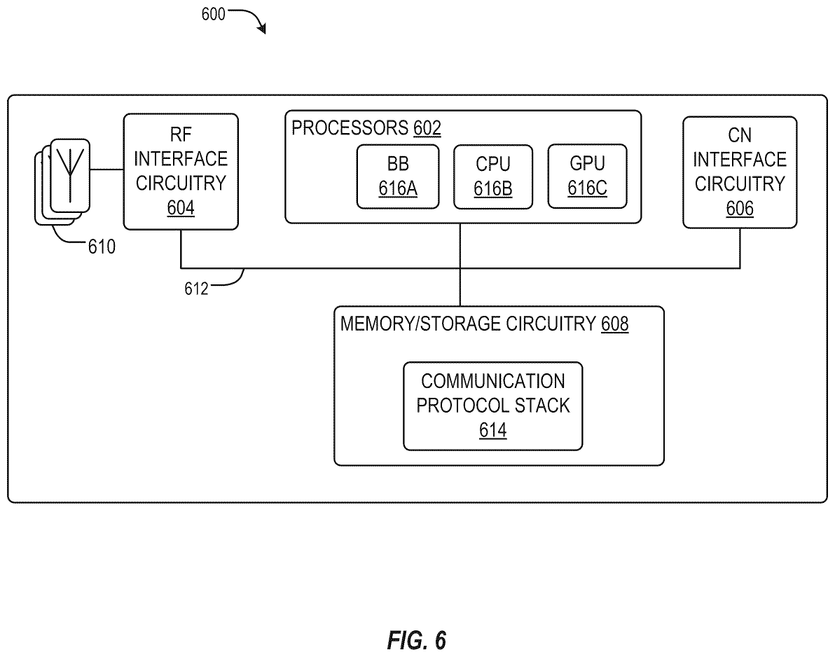

FIG. 6 illustrates an example access node 600 (e.g., a base station or gNB), according to some implementations. The access node 600 may be similar to and substantially interchangeable with base station X104. The access node 600 may include one or more of processor 602, RF interface circuitry 604, core network (CN) interface circuitry 606, memory/storage circuitry 608, and one or more antenna(s) 610. The processor 602 may include any type of circuitry or processor circuitry that executes or otherwise operates computer-executable instructions, such as program code, software modules, or functional processes from memory/storage circuitry 608 to cause the access node 600 to perform operations as described herein.

The components of the access node 600 may be coupled with various other components over one or more interconnects 612. The processor 602, RF interface circuitry 604, memory/storage circuitry 608 (including communication protocol stack 614), antenna(s) 610, and interconnects 612 may be similar to like-named elements shown and described with respect to FIG. Y1. For example, the processor 602 may include processor circuitry such as, for example, baseband processor circuitry (BB) 616A, central processor unit circuitry (CPU) 616B, and graphics processor unit circuitry (GPU) 616C.

The CN interface circuitry 606 may provide connectivity to a core network, for example, a 5th Generation Core network (5GC) using a 5GC-compatible network interface protocol such as carrier Ethernet protocols, or some other suitable protocol. Network connectivity may be provided to/from the access node 600 via a fiber optic or wireless backhaul. The CN interface circuitry 606 may include one or more dedicated processors or FPGAs to communicate using one or more of the aforementioned protocols. In some implementations, the CN interface circuitry 606 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 600 that operates in an NR or 5G system (for example, a gNB), and the term “E-UTRAN node” or the like may refer to an access node 600 that operates in an LTE or 4G system (e.g., an eNB). According to various implementations, the access node 600 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 600 may be implemented as one or more software entities running on server computers as part of a virtual network, which may be referred to as a CRAN and/or a virtual baseband unit pool (vBBUP). In V2X scenarios, the access node 600 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc., as described above in connection with one or more of the preceding figures may be configured to operate in accordance with one or more of the examples set forth below in the examples section.

Example 1 is a method including: determining a spatial multiplexing configuration to use for reception of at least one downlink message; determining a mapping between a single codeword and five or more spatial layers based on the determined spatial multiplexing configuration; and receiving the at least one downlink message using the determined mapping between the single codeword and the five or more spatial layers.

Example 2 includes the method of example 1, where the mapping between the single codeword and the five or more spatial layers is determined according to:

$${x}^{( 0 )} ( i ) = {d}^{( 0 )} ( 5 i )$$

$${x}^{( 1 )} ( i ) = {d}^{( 0 )} ( 5 i + 1 )$$

$${x}^{( 2 )} ( i ) = {d}^{( 0 )} ( 5 i + 2 )$$

$${x}^{( 3 )} ( i ) = {d}^{( 0 )} ( 5 i + 3 )$$

$${x}^{( 4 )} ( i ) = {d}^{( 0 )} ( 5 i + 4 ) ,$$

where x denotes a spatial layer of the five or more spatial layers, d represents the single codeword,

$$i = 0 , 1 , … , {M}_{symb}^{layer} - 1 , {M}_{symb}^{layer}$$

denotes a number of modulation symbols per spatial

$${M}_{symb}^{layer} = {M}_{symb}^{( 0 )} / 5.$$

Example 3 includes the method of any of examples 1 or 2, where determining the spatial multiplexing configuration includes selecting the spatial multiplexing configuration from a table including a set of spatial multiplexing configurations.

Example 4 includes the method of example 3, where each spatial multiplexing configuration of the set of spatial multiplexing configurations is associated with a respective number of spatial layers and a respective number of codewords.

Example 5 includes the method of any of examples 1 to 4, where the determined spatial multiplexing configuration indicates the mapping between the single codeword and the five or more spatial layers.

Example 6 includes the method of any of examples 1 to 5, further including determining an antenna port configuration to use for downlink reception based on the determined spatial multiplexing configuration.

Example 7 includes the method of example 6, where determining the antenna port configuration includes selecting the antenna port configuration from a table including a set of entries, where each entry of the set of entries corresponds to a distinct antenna port configuration.

Example 8 includes the method of any of examples 6 or 7, where determining the antenna port configuration includes receiving DCI that indicates the antenna port configuration.

Example 9 includes the method of any of examples 1 to 8, where determining the mapping between the single codeword and the five or more spatial layers includes determining the mapping between the single codeword and six spatial layers based on the determined spatial multiplexing configuration.

Example 10 includes the method of any of examples 1 to 9, further including transmitting UE capability information that indicates whether five-layer single-codeword reception or five-layer two-codeword reception is supported by a UE.

Example 11 includes the method of example 10, where the spatial multiplexing configuration is determined according to the UE capability information.

Example 12 includes the method of any of examples 10 or 11, where receiving the at least one downlink message includes receiving the at least one downlink message using five or more Rx chains in accordance with the determined spatial multiplexing configuration.

Example 13 is an apparatus including: one or more processors; and memory storing instructions that, when executed by the one or more processors, cause the apparatus to perform the method of any of examples 1-12.

Example 14 is a UE configured to perform the method of any of examples 1-12.

Example 15 is a method including: determining a spatial multiplexing configuration to use for transmission of at least one downlink message; determining a mapping between a single codeword and five or more spatial layers based on the determined spatial multiplexing configuration; and transmitting the at least one downlink message using the determined mapping between the single codeword and the five or more spatial layers.

Example 16 includes the method of example 15, where the mapping between the single codeword and the five or more spatial layers is determined according to:

$${x}^{( 0 )} ( i ) = {d}^{( 0 )} ( 5 i )$$

$${x}^{( 1 )} ( i ) = {d}^{( 0 )} ( 5 i + 1 )$$

$${x}^{( 2 )} ( i ) = {d}^{( 0 )} ( 5 i + 2 )$$

$${x}^{( 3 )} ( i ) = {d}^{( 0 )} ( 5 i + 3 )$$

$${x}^{( 4 )} ( i ) = {d}^{( 0 )} ( 5 i + 4 ) ,$$

where x denotes a spatial layer of the five or more spatial layers, d represents the single codeword,

$$i = 0 , 1 , … , {M}_{symb}^{layer} - 1 , {M}_{symb}^{layer}$$

denotes a number of modulation symbols per spatial layer, and

$${M}_{symb}^{layer} = {M}_{symb}^{( 0 )} / 5.$$

Example 17 includes the method of any of examples 15 to 16, where determining the spatial multiplexing configuration includes selecting the spatial multiplexing configuration from a table including a set of spatial multiplexing configurations.

Example 18 includes the method of example 17, where each spatial multiplexing configuration of the set of spatial multiplexing configurations is associated with a respective number of spatial layers and a respective number of codewords.

Example 19 is an apparatus including: one or more processors; and memory storing instructions that, when executed by the one or more processors, cause the apparatus to perform the method of any of examples 15-18.

Example 20 is a base station configured to perform the method of any of examples 15-18.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

As described above, some aspects of the present technology may relate to the gathering and use of data available from specific and legitimate sources to allow for interaction with a second device for a data transfer. The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used to provide for secure data transfers occurring between a first device and a second device. The personal information data may further be utilized for identifying an account associated with the user from a service provider for completing a data transfer.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. For example, a user may “opt in” or “opt out” of having information associated with an account of the user stored on a user device and/or shared by the user device. In addition to providing “opt in” and “opt out” options, the present disclosure contemplates providing notifications relating to the access or use of personal information. For instance, a user may be notified upon downloading an application that their personal information data will be accessed and then reminded again just before personal information data is accessed by the application. In some instances, the user may be notified upon initiation of a data transfer of the device accessing information associated with the account of the user and/or the sharing of information associated with the account of the user with another device.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users based on aggregated non-personal information data or a bare minimum amount of personal information, such as the content being handled only on the user's device or other non-personal information available to the content delivery services.

We claim:

1. A method comprising:
determining a spatial multiplexing configuration to use for reception of at least one downlink message;
determining a mapping between a single codeword and five or more spatial layers based at least on the determined spatial multiplexing configuration; and
receiving the at least one downlink message using the determined mapping between the single codeword and the five or more spatial layers.

2. The method of claim 1, wherein the mapping between the single codeword and the five or more spatial layers is determined according to:
$${x}^{( 0 )} ( i ) = {d}^{( 0 )} ( 5 i )$$
$${x}^{( 1 )} ( i ) = {d}^{( 0 )} ( 5 i + 1 )$$
$${x}^{( 2 )} ( i ) = {d}^{( 0 )} ( 5 i + 2 )$$
$${x}^{( 3 )} ( i ) = {d}^{( 0 )} ( 5 i + 3 )$$
$${x}^{( 4 )} ( i ) = {d}^{( 0 )} ( 5 i + 4 ) ,$$
wherein x denotes a spatial layer of the five or more spatial layers, d represents the single codeword,
$$i = 0 , 1 , … , {M}_{symb}^{layer} - 1 , {M}_{symb}^{layer}$$
denotes a number of modulation symbols per spatial layer, and
$${M}_{symb}^{layer} = {M}_{symb}^{( 0 )} / 5.$$

3. The method of claim 1, wherein determining the spatial multiplexing configuration comprises selecting the spatial multiplexing configuration from a table comprising a plurality of spatial multiplexing configurations.

4. The method of claim 3, wherein each spatial multiplexing configuration of the plurality of spatial multiplexing configurations is associated with a respective number of spatial layers and a respective number of codewords.

5. The method of claim 1, wherein the determined spatial multiplexing configuration indicates the mapping between the single codeword and the five or more spatial layers.

6. The method of claim 1, further comprising determining an antenna port configuration to use for downlink reception based at least on the determined spatial multiplexing configuration.

7. The method of claim 6, wherein determining the antenna port configuration comprises selecting the antenna port configuration from a table comprising a plurality of entries, wherein each entry of the plurality of entries corresponds to a distinct antenna port configuration.

8. The method of claim 6, wherein determining the antenna port configuration comprises receiving downlink control information (DCI) that indicates the antenna port configuration.

9. The method of claim 1, wherein determining the mapping between the single codeword and the five or more spatial layers comprises determining the mapping between the single codeword and six spatial layers based at least on the determined spatial multiplexing configuration.

10. The method of claim 1, further comprising transmitting user equipment (UE) capability information that indicates whether five-layer single-codeword reception or five-layer two-codeword reception is supported by a UE.

11. The method of claim 10, wherein the spatial multiplexing configuration is determined according to the UE capability information.

12. The method of claim 10, wherein receiving the at least one downlink message comprises receiving the at least one downlink message using five or more receive (Rx) chains in accordance with the determined spatial multiplexing configuration.

13. A method comprising:
determining a spatial multiplexing configuration to use for transmission of at least one downlink message;
determining a mapping between a single codeword and five or more spatial layers based at least on the determined spatial multiplexing configuration; and
transmitting the at least one downlink message using the determined mapping between the single codeword and the five or more spatial layers.

14. The method of claim 13, wherein the mapping between the single codeword and the five or more spatial layers is determined according to:
$${x}^{( 0 )} ( i ) = {d}^{( 0 )} ( 5 i )$$
$${x}^{( 1 )} ( i ) = {d}^{( 0 )} ( 5 i + 1 )$$
$${x}^{( 2 )} ( i ) = {d}^{( 0 )} ( 5 i + 2 )$$
$${x}^{( 3 )} ( i ) = {d}^{( 0 )} ( 5 i + 3 )$$
$${x}^{( 4 )} ( i ) = {d}^{( 0 )} ( 5 i + 4 ) ,$$
wherein x denotes a spatial layer of the five or more spatial layers, d represents the single codeword
$$i = 0 , 1 , … , {M}_{symb}^{layer} - 1 , {M}_{symb}^{layer}$$
denotes a number of modulation symbols per spatial layer, and
$${M}_{symb}^{layer} = {M}_{symb}^{( 0 )} / 5.$$

15. The method of claim 13, wherein determining the spatial multiplexing configuration comprises selecting the spatial multiplexing configuration from a table comprising a plurality of spatial multiplexing configurations.

16. The method of claim 15, wherein each spatial multiplexing configuration of the plurality of spatial multiplexing configurations is associated with a respective number of spatial layers and a respective number of codewords.

17. The method of claim 15, wherein the determined spatial multiplexing configuration indicates the mapping between the single codeword and the five or more spatial layers.

18. The method of claim 15, further comprising determining an antenna port configuration to use for downlink transmission based at least on the determined spatial multiplexing configuration.

19. An apparatus comprising:
one or more processors; and
memory storing instructions that, when executed by the one or more processors, cause the apparatus to perform operations comprising:
determining a spatial multiplexing configuration to use for reception of at least one downlink message;
determining a mapping between a single codeword and five or more spatial layers based at least on the determined spatial multiplexing configuration; and
receiving the at least one downlink message using the determined mapping between the single codeword and the five or more spatial layers.

20. The apparatus of claim 19, wherein the mapping between the single codeword and the five or more spatial layers is determined according to:
$${x}^{( 0 )} ( i ) = {d}^{( 0 )} ( 5 i )$$
$${x}^{( 1 )} ( i ) = {d}^{( 0 )} ( 5 i + 1 )$$
$${x}^{( 2 )} ( i ) = {d}^{( 0 )} ( 5 i + 2 )$$
$${x}^{( 3 )} ( i ) = {d}^{( 0 )} ( 5 i + 3 )$$
$${x}^{( 4 )} ( i ) = {d}^{( 0 )} ( 5 i + 4 )$$
wherein x denotes a spatial layer of the five or more spatial layers, d represents the single codeword,
$$i = 0 , 1 , … , {M}_{symb}^{layer} - 1 , {M}_{symb}^{layer}$$
denotes a number of modulation symbols per spatial layer, and
$${M}_{symb}^{layer} = {M}_{symb}^{( 0 )} / 5.$$
